(19) United States
(12) Patent Application Publication
(10) Pub. No.: US 2004/0129770 A1
(43) Pub. Date: Jul. 8, 2004

(54) Ordering system using a mobile terminal that provides positional information

(75) Inventor: Yoshiaki Masuno, Fujisawa-shi (JP)

Correspondence Address: JORDAN AND HAMBURG LLP, 122 EAST 42ND STREET, SUITE 4000, NEW YORK, NY, 10168, US

(73) Assignee: GIPPIES, INC., Kamakura-shi (JP)

(21) Appl. No.: 10/739,450

(22) Filed: Dec. 17, 2003

(30) Foreign Application Priority Data
Feb. 6, 2002 (JP) 2002-069335

(51) Int. Cl. G06F 17/00

(52) U.S. Cl. 235/375

(57) ABSTRACT

In an ordering system utilizing a mobile terminal that is capable of sending positional information, a person who carries the mobile terminal makes an order via the mobile terminal based on observation of a product or service on site and pays for it by using an online payment system via the mobile terminal, in which the mobile terminal sends positional information to an order receiving party so that the order receiving party can find the location of the person and deliver the product or service ordered to the person.

### BACKGROUND OF THE INVENTION

1. Background of the Invention

The present invention relates to an ordering system utilizing a mobile terminal that provides positional information.

2. Description of the Prior Art

Recently, in addition to an ordinary telephone function, various functions such as i-mode web browsing are available on mobile phones or mobile terminals. Such web browsing allows users to access various information services, for example, train transfer information and area information services. Also, users can do shopping via mobile phones or terminals by using electronic payment system. Some private railroads sell reserved seats through mobile phone web services. Not only mobile phones, but also various types of mobile terminals such as PHSs (Personal Handyphone System) and palm top PCs equipped with a telephone function have been developed. Recently, mobile phones or terminals further equipped with positional information recognition functions such as GPS (Global Positioning System) have been developed. Such a mobile terminal with a positional information recognition function, which can recognize the current position and send the positional information to other terminals or servers, is hereinafter referred as “positional information mobile terminal”.

Currently, a growing number of the information mobile terminal have been developed and put into practical use, particularly in a situation where a user needs to send the current location of himself or herself to other persons. However, in various online ordering systems, the positional information provided by these positional information mobile terminals are unlikely to be effectively used even in a case where a transaction is made via the mobile terminals. Although there are some cases that the current location sent from the positional information mobile terminal is reflected to some extent in some online area information services, still they are not enough to make the best use of characteristics of the positional information mobile terminals.

### SUMMARY OF THE INVENTION

The present invention has been conceived to solve the above problem. It is an object of the present invention to provide an ordering system that effectively utilizes the positional information sent from a mobile terminal carried by the user.

According to one aspect of the present invention, there is provided an ordering system utilizing a mobile terminal that is capable of sending positional information, in which a person who carries the mobile terminal makes an order via the mobile terminal based on observation of a product or service on site and pays for it by using an online payment system via the mobile terminal, in which the mobile terminal sends positional information to an order receiving party so that the order receiving party can find the location of the person and deliver the product or service ordered to the person. Specifically, the positional information sent from the mobile terminal is provided by utilizing a GPS (Global Positioning System) or a PHS cell station in a case where a PHS is used as the mobile terminal.

According to another aspect of the present invention, there is provided an ordering system utilizing a mobile terminal that is capable of sending positional information, in which a person who carries the mobile terminal makes an order via the mobile terminal based on observation of a product or service on site and pays for it in cash, in which the mobile terminal sends positional information to an order receiving party so that the order receiving party can find the location of the person and deliver the product or service ordered to the person.

According to another aspect of the present invention, there is provided an ordering system utilizing a mobile terminal that is capable of sending positional information, in which a person who carries the mobile terminal sends positional information via the mobile terminal to a receiving party so that the receiving party finds the location of the person and provides the person with the information on products or services available in an area determined on the basis of the positional information sent by the mobile terminal, enabling the person to order a product or service that is available in the area via the mobile terminal. Specifically, the positional information sent from the mobile terminal is provided by utilizing a GPS (Global Positioning System) or a PHS (Personal Handyphone System) cell station in a case where a PHS is used as the mobile terminal. In this ordering system, a shop or any other receiving party accepts the order from the person, when a product or service ordered is available in an area determined by the positional information sent from the mobile terminal carried by the person. Otherwise, the order will not be accepted. When plural products or services are provided in the area, some menus extracted may be shown on a display of the mobile terminal.

According to another aspect of the present invention, there is provided an ordering system utilizing a mobile terminal that is capable of sending positional information, in which a person who carries a mobile terminal sends patch information containing personal information that includes at least one of age, health condition and driver's license information, as well as positional information via the mobile terminal to a receiving party, so that the receiving party receives the patch information and the positional information, and provides the person with the information on a product or service available for the person in an area determined by the patch information. This ordering system enables the person to receive more suitable information. That is, if the person is allergic to some ingredients, a receiving party may be able to provide a menu which does not contain those ingredients so that the person can enjoy food or the like without fear. Also, the receiving party may be able to prevent selling certain products such as cigarettes to a person under a certain age.

According to still another aspect of the present invention, there is provided an ordering system utilizing a mobile terminal that is capable of sending positional information, in which a person who carries a mobile terminal orders a product via the mobile terminal by using an online payment system, so that an order receiving party provides a free web access service for the person for a certain time corresponding to the amount paid by electronic payment. This ordering system may be useful such as in a coffee shop where a wireless LAN equipment is provided. The person who ordered a drink can enjoy a free web access service for a certain time upon the payment, through the mobile terminal, through which the order was made.

According to yet another aspect of the present invention, there is provided an ordering system utilizing a mobile terminal that is capable of sending positional information, in which a person who carries the mobile terminal sends patch information that includes a product to be purchased as well as positional information, and a receiving party receives the patch information and sends the information on the location of the product along with the location of the person to the mobile terminal, so that the person can check the location of the product along with the location of the person on a display of the mobile terminal, enabling the person to easily find the location of the product to be purchased. Where this ordering system is used in a supermarket, the person sends the patch information containing a menu for dinner such as to a website of the supermarket. The supermarket then provides the person with the information on the locations of foodstuff, seasoning or the like for it so that the person can check the locations of them along with the location of himself or herself on the display of the mobile terminal. Thus, the person can easily and instantly purchase them. In this ordering system, there is also possible that the patch information contains a budget, acceptable calorie intake, stock already available in the person's house or the like. Accordingly, the receiving party can provide more suitable information to the person.

### BRIEF DESCRIPTION OF THE DRAWINGS

The above, and other objects, features and advantages of the present invention will become apparent from the detailed description thereof in conjunction with the accompanying drawing wherein.

FIG. 1 is schematic views illustrating different applications of the positional information mobile terminal according to the present invention.

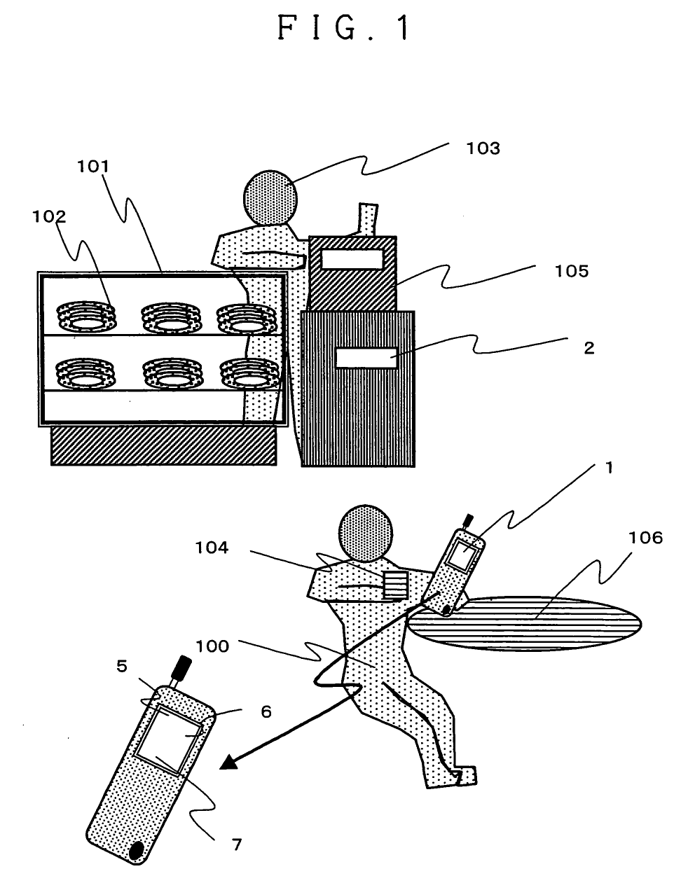

### DETAILED DESCRIPTION OF THE PREFERRED EMBODIMENT

With reference to the attached drawings, the description will be made for embodiments of present invention.

Here is an example of an ordering system utilizing a mobile phone at a coffee shop that serves coffee, teas and snacks. First, a case where a mobile phone is not used will be briefly mentioned. A customer 100 takes a look at various food items (donuts 102 in this example) displayed in a showcase 101 and determines which donuts and how many to order. The customer then tells the numbers and kinds of donuts 102 to a shop clerk 103, as well as ordering a cup of coffee 104. The shop clerk prepares for the ordered donuts. The customer then pays for the order at a register 105, receives the donuts, moves to a self-service counter for a cup of coffee and eats at a table 106.

Now, the description will be made for a case where the coffee shop employs an ordering system that utilizes a positional information mobile terminal carried by a customer. The customer 100 who carries a positional information mobile terminal 1 takes a look at food items such as donuts 102 displayed in the showcase 101 and determines which donuts and how many to order in the same manner as above. The customer 100 is informed of a URL 2 of a website of the shop, which information may be posted some place in the store. The customer 100 then accesses via his or her mobile terminal 1 to a website of the coffee shop where an online ordering service is provided. The customer 100 signs up for a membership required for the online ordering service by submitting credit card or electronic check details, as well as mobile phone number, email address or the like. This sign-up can be made any time prior to using this online service provided by the shop. The customer 100 then sees a page of the website on a display of the mobile terminal, where the items of foods and beverage in the showcase and their orders are shown and then orders the items of foods and beverages (donuts 102 and coffee in this example) by inputting the items and the number of each item or selecting them on a list or menu. The payment for this order is settled through an electronic payment system and a series of ordering and paying operations are completed hereby.

After the series of operations described above, the customer 100 walks to the table 106 or a beverage self-service counter at which the customer 100 pours a cup of coffee. While the customer 100 is waiting for the ordered items as drinking coffee or doing something, a shop clerk prepares for the donuts 102. Then, the shop clerk who prepared the ordered items calls the customer's mobile terminal or sends email at the address registered to inform that the donuts are ready to be served. Once the customer 100 has received a call or email, he or she motions to the shop clerk to notice his or her place and allow the shop clerk to bring the ordered items to the table 106. During this service, the customer 100 can easily check if the order is correctly processed with reference to a record of the shop provided at the website on the screen of the mobile terminal. For a customer who uses this ordering system that utilizes the mobile terminal and electronic payment system, the coffee shop may provide a special service such as giving a discount to compensate for the telephone bill charge incurred by this ordering service or provide a service equivalent to it. The service may include presenting a current or new type of products every time at which the amount paid reaches a certain level. This embodiment has been described by taking for example where the customer orders donuts via the mobile terminal based on observation on site. A PHS or any other mobile communication device may be used in this ordering system.

In a case where the user with the positional information mobile terminal such as a mobile phone or PHS, which is retained in “ON” state to constantly provide the positional information, moves into an area where various online information services are available, such positional information allows the user to easily access the information provided by various shops or restaurants in the area. In this case, the information provided by shops or restaurants may be automatically and continuously displayed on the display of the mobile terminal as far as the user is located in the network information service area. In this embodiment, once the user has decided to order some items or services, the order can be made by using an online ordering system before he or she visits a shop or restaurant. As a result, the user can easily obtain the necessary information even in an unfamiliar area, and easily access to a shop or restaurant by following a guidance or map displayed on the display of the mobile terminal, as well as receiving the ordered item or service without waiting time at the shop or restaurant. Also, for these shops or restaurants, the ordering system of this embodiment allows them to utilizes itself as an effective marketing or advertising medium.

Now, the description will be made for a second embodiment of the present invention by taking for example a case where the ordering system using the positional information mobile terminal is employed in a restaurant, bar or the like, without reference to the drawing. Assuming that a customer takes a seat and chooses foods and drinks looking at a menu set on a table or provided by a waiter or waitress, each dish or beverage on the menu may be allocated a code. In such a case, the customer accesses a website and views an ordering page linked thereto on the display of the positional information mobile terminal carried by the customer and inputs corresponding codes allocated respectively to dishes or beverages and the number of each dish or beverage the client desires to have. The allocation of codes may simplify the load of the user to input the order into the mobile terminal.

Before sending the order, the customer inputs a table number allocated to the table where the customer is seated. In a case that a customer sends the order via the positional information mobile terminal, the table number sent from the positional information terminal of the customer is then automatically compared with the registered table number in a server or the like operated by the restaurant. Once the table number has been identified, the order is accepted and subsequently processed. Alternatively, the positional information sent from the mobile terminal may be used to identify the location of the customer. In this case, the customer does not need to input the table number and the restaurant also does not need to prepare a server equipped with the table number identification function. The positional information may be used together with the table number identification process to improve accuracy in locating the customer.

In a case where a mobile terminal is equipped with a bar code reader, the customer can simplify the load to input the order by reading a bar code allocated to each dish on a menu. In a similar manner to the first embodiment, the customer may access the restaurant's web site via the mobile terminal, send an order in advance and receive an online order receipt before visiting the restaurant. At the restaurant, the customer shows the online order receipt displayed on the screen of the mobile terminal to a person of the restaurant. Accordingly, the customer may be able to receive a service at the restaurant without waiting time. In a case where the mobile terminal is equipped with a wireless LAN capability and the restaurant correspondingly provides a wireless LAN service, the customer may be able to order through the wireless LAN service. In this case, the positional information sent from the mobile terminal is effective for the restaurant to locate the customer. By ordering this way, the customer can have an advantage over other customers such as in a restaurant's busy time since he or she does not need to wait on line for the order. This ordering system is also applicable to hamburger shops, coffee shops or any other shops. In this embodiment, the electronic payment system is also useful because a series of ordering and payment procedures can be made in advance outside a shop or restaurant via the positional information mobile terminal.

Now, the description will be made for a third embodiment of the ordering system by taking for example a case where a lunch delivery service is ordered through the positional information mobile terminal. A customer in his or her room or any other place outside of a delivery shop accesses a website provided by the delivery shop and orders a delivery service through the location mobile terminal. In this case, the positional information sent from the mobile terminal is useful for a delivery shop to locate the customer. This contributes to a quick delivering of the order.

In addition to the way of use of the ordering system as mentioned above, the positional information sent from the mobile terminal may be useful in accessing delivery services available in an area where the customer resides. Delivery services may be categorized into several groups according to the type of services and products, region of the area, time during which the service is available, or any other factors. In this case, the customer can easily find a service or product, which he or she desires to order, through the categorized groups displayed on the display of the mobile terminal. For example, in a case where the customer desires to have lunch delivered to him or her, the customer selects a food with reference to a menu or table on the display of the mobile terminal, in which food delivery services, meals' images, prices, calories and the like are shown. The customer, once he or she finds a food to have, orders a lunch delivery for it only by online access through the positional information mobile terminal. Because the positional information mobile terminal carried by the customer continuously sends the positional information to the area service information site, the location of the customer can be easily and accurately followed by the area service information site. As a result, the site can provide the information more suitable for the customer.

In a case where the personal data of the customer is previously stored in a memory part of the positional information mobile terminal or registered at a certain site, it is useful in finding a store more suitable for the customer through the area service information site. For example, where the customer has diabetes or is allergic to some ingredients, these information are sent from the mobile terminal or a site at which these information are registered to the area service information site that in turn selects shops which provide proper foodstuff for a person who is diabetic or allergic to some ingredients, and shows the shops on the display. By accessing a website of a selected shop, more detailed information on a menu suitable for the customer can be displayed on the display of the local information mobile terminal. Where a demand for protecting persons under a certain age for a certain product or service exists, his or her age may be sent together with the order. This function may be useful in protecting persons under a certain age who try to order alcohol. As mentioned above, this data may be registered at a certain site operated by such as a certificate authority so that the registered information is prevented from being tampered.

Now, the description will be made for a forth embodiment of the ordering system by taking for example a case where the positional information mobile terminal is used to order a product displayed on site such as at a marketplace where many shops display and sell their products. This kind of a marketplace is frequently held in a train station yard to provide an open space to allowing them to sell various products such as accessories, bags, clothes, home appliance and the like. In this case, the customer can check every detail of a product by touching, picking up or smelling the product itself or a sample of it before ordering in the same manner as usually done. Once the customer decides to purchase it, the customer accesses a website operated by the shop by using the positional information mobile terminal, at which the order is made and payment is settled by electronic money or a credit card. Since the positional information terminal sends the positional information, a shop attendant can easily and instantly find the location of the customer. This function is effective particularly in a situation where the marketplace occupies a large space, or the number of shop attendants is limited. A shop employing this ordering system thus provides a service to the customer on site without waiting time, as well as providing such as delivering service without causing a trouble for the customer to fill in his or her address on a necessary form, as far as the customer wishes to receive the purchased product at the address registered. This ordering system is useful in purchasing a bulky product such as a big bottle of drinking water (e.g., a 1.5 liter bottle). In this case, the customer may try water provided as a sample at a drink corner of the marketplace. If the customer likes it and decides to order, for example, 3 bottles of water, the customer sends patch information containing personal data needed for a delivery including the customer's home address via the positional information mobile terminal during online ordering procedure. Thus, this ordering system contributes to ease of purchasing even a bulky product to be delivered.

Now, the description will be made for a fifth embodiment of the ordering system by taking for example a case where the positional information mobile terminal is carried by not only the customer but also a vendor who has been selling foods or other articles by a wagon, cart, trailer, motortruck, or the like on the street. In this ordering system, the customer can easily find at an area information service site the information as to whether a vendor is available in the neighborhood. Once the customer finds an available vendor, the order is made through the positional information mobile terminal in the same manner as the aforementioned embodiment. In this case, the positional information sent from the mobile terminal carried by the customer is also useful for a delivery service if it is provided by the vendor. The vendor may make a proposal to move near the customer's neighborhood for the customer's convenience once the order has been made.

In the above case, for example, the vendor may automatically or manually reply to the customer, upon receiving the order from the customer via the positional information mobile terminal, whether the order can be or cannot be accepted. The determination on this may be made on the basis of the distance between the vendor's current location and the customer's location. That is, the vendor determines whether the location of the customer is within an area the vendor can move to. This ordering manner is also applicable to various services such as a trade-in service of electrical appliances, which uses a motortruck to provide a service on site such as in a residence area.

This specification is by no means intended to restrict the present invention to the preferred embodiments set forth therein. Various modifications to the ordering system, as described herein, may be made by those skilled in the art without departing from the spirit and scope of the present invention as defined in the appended claims.

What is claimed is:

1. An ordering system utilizing a mobile terminal that is capable of sending positional information, in which a person who carries the mobile terminal makes an order via the mobile terminal based on observation of a product or service on site and pays for it by using an online payment system via said mobile terminal, in which said mobile terminal sends positional information to an order receiving party so that the order receiving party can find the location of the person and deliver the product or service ordered to the person.

2. An ordering system utilizing a mobile terminal that is capable of sending positional information, in which a person who carries the mobile terminal makes an order via the mobile terminal based on observation of a product or service on site and pays for it in cash, in which said mobile terminal sends positional information to an order receiving party so that the order receiving party can find the location of the person and deliver the product or service ordered to the person.

3. An ordering system utilizing a mobile terminal that is capable of sending positional information, in which a person who carries the mobile terminal sends positional information via the mobile terminal to a receiving party so that said receiving party finds the location of the person and provides the person with the information on products or services available in an area determined on the basis of the positional information sent by the mobile terminal, enabling the person to order a product or service that is available in the area via the mobile terminal.

4. An ordering system utilizing a mobile terminal that is capable of sending positional information, in which a person who carries a mobile terminal sends patch information containing personal information that includes at least one of age, health condition and driver's license information, as well as positional information via the mobile terminal to a receiving party, so that the receiving party receives the patch information and the positional information, and provides the person with the information on a product or service available for the person in an area determined by the patch information.

5. An ordering system utilizing a mobile terminal that is capable of sending positional information, in which a person who carries a mobile terminal orders a product via the mobile terminal by using an online payment system, so that an order receiving party provides a free web access service for the person for a certain time corresponding to the amount paid by electronic payment.

6. An ordering system utilizing a mobile terminal that is capable of sending positional information, in which a person who carries the mobile terminal sends patch information that includes a product to be purchased as well as positional information, and a receiving party receives said patch information and sends the information on the location of the product along with the location of the person to said mobile terminal, so that the person can check the location of the product along with the location of the person on a display of said mobile terminal, enabling the person to easily find the location of the product to be purchased.
